(19) United States
(12) Patent Application Publication
(10) Pub. No.: US 2014/0102684 A1
(43) Pub. Date: Apr. 17, 2014

(54) HOT GAS PATH COMPONENT COOLING FILM HOLE PLATEAU

(71) Applicant: GENERAL ELECTRIC COMPANY, Schenectady, NY (US)

(72) Inventors: Ibrahim Sezer, Greenville, SC (US); Gary Michael Itzel, Simpsonville, SC (US)

(73) Assignee: GENERAL ELECTRIC COMPANY, Schenectady, NY (US)

(21) Appl. No.: 13/651,601

(22) Filed: Oct. 15, 2012

(51) Int. Cl. F28F 3/00; B22D 23/00; B05D 7/00; B05D 3/14; B05D 5/00

(52) U.S. Cl. 165/168; 427/299; 164/76.1; 427/540; 427/282; 427/271; 427/256

(57) ABSTRACT

A component for use in a hot gas path of a turbomachine, and a method of constructing the same are disclosed. In an embodiment, the component includes an exterior wall substrate, wherein the exterior wall substrate includes an interior face and an exterior face, and a plurality of plateaus disposed on the exterior face. A plurality of cooling holes are formed, providing a fluid passageway between the interior face and the exterior face of the exterior wall substrate. Each cooling hole is disposed such that it passes through a plateau. A first coating layer is deposited over the exterior face of the exterior wall substrate.

### BACKGROUND OF THE INVENTION

The invention relates generally to protective-coated hot gas path components for turbine assemblies, and more particularly, to a cooling film hole plateau disposed on an exterior surface of the hot gas path component.

Components in the working fluid flow path of turbines such as, e.g., gas turbines, are typically subjected to high temperatures during operation. These operating temperatures may contribute to undesirable conditions.

Various methods have been employed to cool hot gas path components to extend their useful life. Hot gas path components may be coated with thermal barrier coatings (TBCs) which insulate the components and can sustain an appreciable temperature difference between the load-bearing alloys and the coating surface, thus limiting the thermal exposure of the structural component. Film cooling is often used in conjunction with TBCs. Film cooling involves injecting air through holes in the surface of the component, from a source such as a compressor bleed flow which bypasses a combustor. The relatively cooler air enters the hot gas path and forms an insulating layer between the hot gas and the component, further reducing heat flux into the component.

Cooling holes may be formed in a component using a variety of methods such as, for example, electrical discharge machining (EDM). Machining methods such as EDM do not facilitate machining through the protective TBC which are applied to many components. Accordingly, cooling holes in many cases require manual cutting or grinding.

### BRIEF DESCRIPTION OF THE INVENTION

A first aspect of the disclosure provides a component for use in a turbomachine. The component includes an exterior wall substrate having an interior face and an exterior face, and a plurality of plateaus disposed on the exterior face. A plurality of cooling holes provide a fluid passageway between the interior face and the exterior face of the exterior wall substrate. Each cooling hole in the plurality of cooling holes is disposed such that it passes through one of the plurality of plateaus. A first, non-metallic coating layer is disposed on the exterior face of the exterior wall substrate, wherein the first coating layer does not coat an exterior face of each plateau in the plurality of plateaus.

A second aspect of the disclosure provides a method of constructing a component for use in a turbomachine. The method includes forming an exterior wall substrate, wherein the exterior wall substrate includes an interior face and an exterior face, and a plurality of plateaus disposed on the exterior face. A plurality of cooling holes are formed, providing a fluid passageway between the interior face and the exterior face of the exterior wall substrate. Each cooling hole is disposed such that it passes through one of the plurality of plateaus. A first, non-metallic coating layer is deposited on the exterior face of the exterior wall substrate.

These and other aspects, advantages and salient features of the invention will become apparent from the following detailed description, which, when taken in conjunction with the annexed drawings, where like parts are designated by like reference characters throughout the drawings, disclose embodiments of the invention.

### BRIEF DESCRIPTION OF THE DRAWINGS

FIG. 1 shows a simplified schematic illustration of a gas turbine system.

FIGS. 2A-B show a top cross-sectional view of a component (FIG. 2A) in the form of an airfoil, and of a detailed cross-sectional view of a cooling hole and plateau (FIG. 2B) in accordance with an embodiment of the disclosure.

FIG. 3 shows a cross sectional view of a portion of a component in the form of an airfoil in accordance with an embodiment of the disclosure.

FIG. 4 shows a cross sectional view of a component in the form of an airfoil in accordance with an embodiment of the disclosure.

FIG. 5 shows a perspective view of a portion of a component in the form of an airfoil, and a component in the form of a sidewall in accordance with embodiments of the disclosure.

FIG. 6 shows a cross sectional view of a portion of a component in a combustor environment in accordance with an embodiment of the disclosure.

FIG. 7 shows a cross sectional view of a portion of a component in the form of a shroud in accordance with an embodiment of the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

At least one embodiment of the present invention is described below in reference to its application in connection with the operation of a gas turbine system. Although embodiments of the invention are illustrated relative to a gas turbine system, it is understood that the teachings are equally applicable to other electric machines in which components are subjected to high temperatures, including other types of combustion systems. Further, at least one embodiment of the present invention is described below in reference to a nominal size and including a set of nominal dimensions. However, it should be apparent to those skilled in the art that the present invention is likewise applicable to any suitable turbine and/or compressor. Further, it should be apparent to those skilled in the art that the present invention is likewise applicable to various scales of the nominal size and/or nominal dimensions.

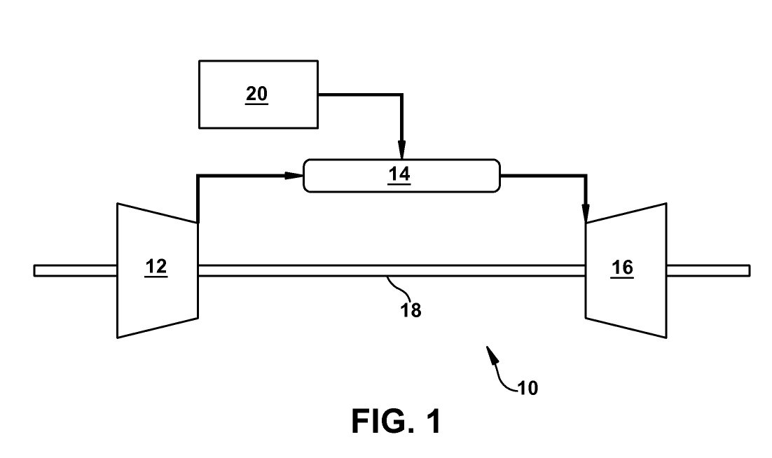

Referring to the drawings, FIG. 1 shows a schematic view of a gas turbine system 10 in simplified form. The system 10 may include one or more compressors 12, combustors 14, turbines 16, and fuel nozzles 20. Compressor 12 and turbine 16 may be coupled by one or more shafts 18. Shaft 18 may be a single shaft or may be made up of multiple shaft segments coupled together.

Gas turbine system 10 may include a number of hot gas path components. The term, “hot gas path component” refers to any component of system 10 that is at least partially exposed to a high temperature flow of gas through system 10. For example, bucket (blade) assemblies, nozzle (vane) assemblies, shroud assemblies, transition pieces, retaining rings, and combustor exhaust components are all examples of hot gas path components, although this is not intended to be an exhaustive recitation.

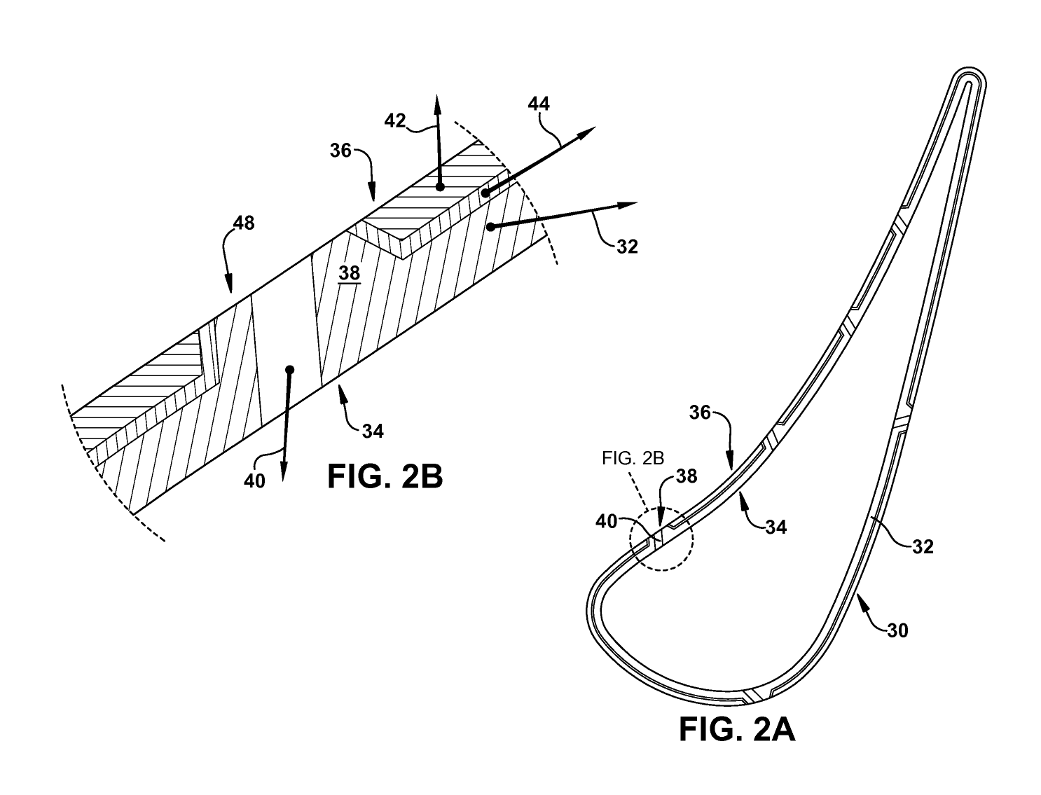

FIGS. 2A-B show a top view cross-section of an exemplary airfoil component 30 (FIG. 2A), and an inset detailed view of cooling hole 40 (FIG. 2B). As shown in FIG. 2A, component 30 (in the form of an airfoil in FIGS. 2A-B, 3 and 4) includes an exterior wall substrate 32, having an interior face 34 and an exterior face 36. Exterior wall substrate 32 may be made of a metal. Depending on the intended application for the component, exterior wall substrate 32 may be, for example, a nickel-based superalloy.

As shown in FIG. 2B, a plurality of cooling holes 40 provide a fluid passageway between the interior face 34 and the exterior face 36 of the exterior wall substrate 32. Each cooling hole 40 is disposed such that it passes through a plateau 38 en route between interior and exterior faces 34, 36 as shown in FIG. 2B. Each component 30 may include as many as 300 cooling holes 40 or more.

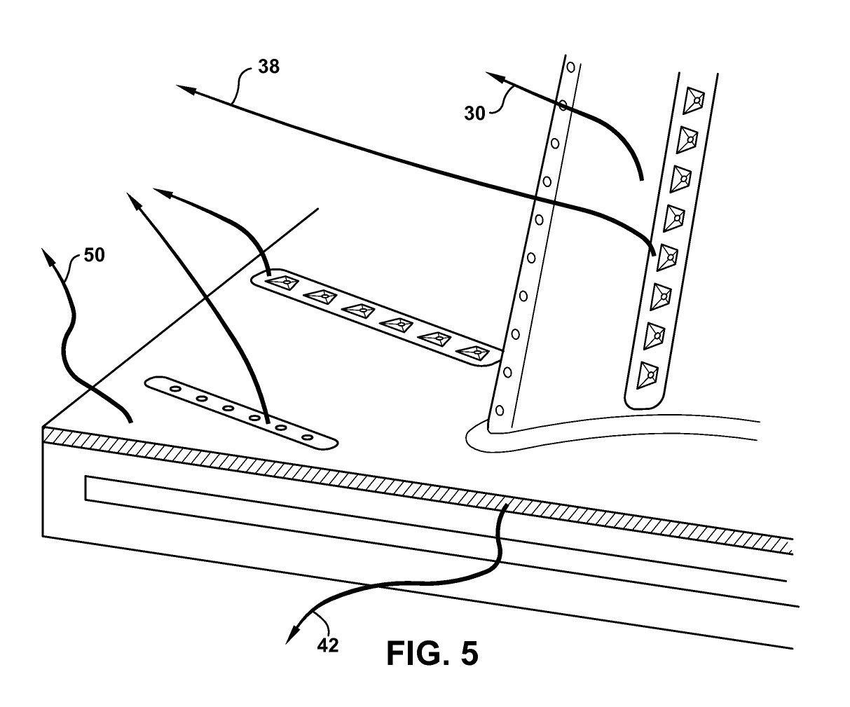

A plurality of plateaus 38, or raised features, are disposed on the exterior face 36. In various embodiments, each plateau may have a width of about 0.0254 cm-1.02 cm (about 0.010 in. to about 0.4 in.) and a height of about 0.013 cm to about 0.178 cm (about 0.005 in. to about 0.070 in.). Plateaus 38 may be arranged in strips on component. In some embodiments, as shown in FIG. 5, a plateau 38 may run the length of a row of cooling holes 40, such that all cooling holes 40 in a single row are contained in a single plateau 38. In other embodiments, component 30 may include a plurality of plateaus 38 arranged in a row, with each cooling hole 40 having its own plateau 38. Various combinations of these embodiments may also be used, in which a plateau 38 contains more than one cooling hole 40, but fewer than an entire row of cooling holes 40. In further embodiments, cooling holes 40 and plateau(s) 38 may be arranged in a linear row, or may be arranged in a curved or arced pattern. The curved or arced arrangement may be curved radially, axially, or both radially and axially, depending on the shape of component 30 and its cooling requirements.

A first coating layer 42 may be disposed on the exterior face 36 of the exterior wall substrate 32. First coating layer 42 may comprise a non-metallic, and in particular a ceramic material. In some embodiments, first coating layer 42 may be formed by depositing one or more layers of the non-metallic material. In some embodiments, a second coating layer 44 may be present, disposed between first coating layer 42 and exterior face 36 of exterior wall substrate 32. Second coating layer may comprise a metallic bonding layer. Like first coating layer 42, in some embodiments, second coating layer 44 may be formed by depositing one or more layers of the metallic material. Additional layers beyond first coating layer 42 and second coating layer 44 may also be present. Collectively, first and second coating layers 42, 44 and any additional layers form a thermal barrier coating over exterior wall substrate 32. In some embodiments, first coating layer 42 has a thickness that is less than or equal to a height of plateau 38. In further embodiments, a combined thickness of first and second coating layers 42, 44 is less than or equal to a height of plateau 38. As a result, first coating layer 42 may not coat an exterior face 48 of each plateau 38 in the plurality of plateaus 38, as shown in FIG. 2B.

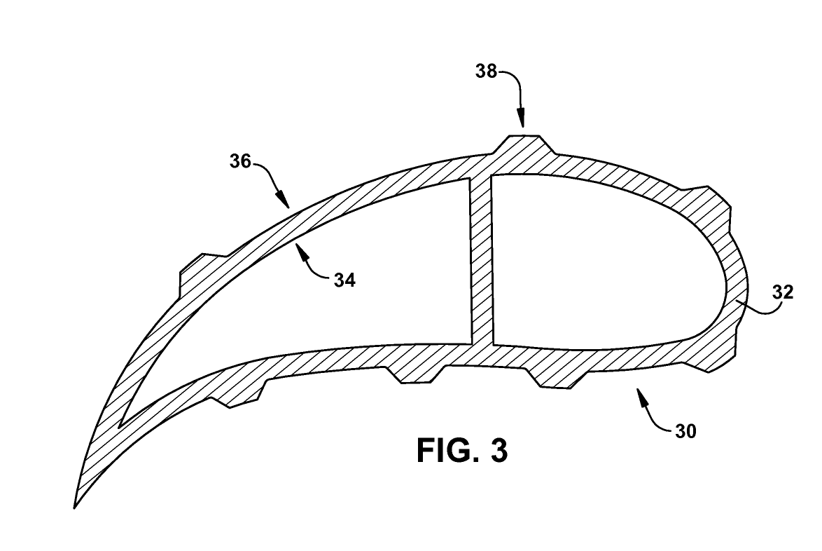

Turning to FIG. 3, a method of constructing component 30 will now be described.

Initially, an exterior wall substrate 32 is formed by any conventional means such as, e.g., casting. The exterior wall substrate includes an interior face 34 and an exterior face 36. Exterior wall substrate 32 may be made of metal such as, for example, a nickel-based superalloy. A plurality of plateaus 38 are disposed on the exterior face 36. Plateaus 38 may be formed, for example, by milling the external surface of component 30 to form plateau 38. In other embodiments, component 30 may be cast including plateaus 38.

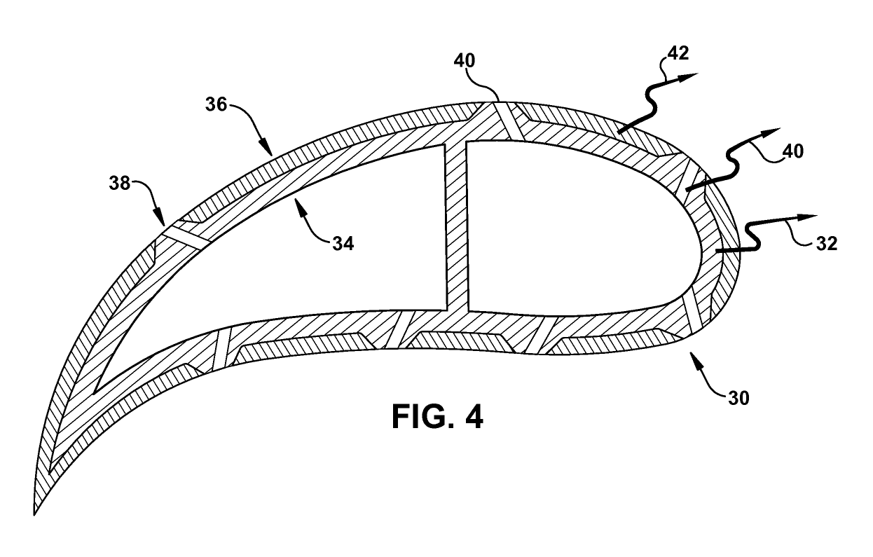

Turning to FIG. 4, a first coating layer 42 may be deposited on the exterior face 36 of the exterior wall substrate 32. In some embodiments, first coating layer 42 comprises a non-metallic material which may be ceramic. As further shown in FIG. 4, a plurality of cooling holes 40 may be formed, providing a fluid passageway between the interior face 34 and the exterior face 36 of the exterior wall substrate 32. Each cooling hole 40 is disposed such that it passes through a plateau 38. Thus, plateaus 38 are formed in each location on exterior wall substrate 32 where a cooling hole 40 is desired.

In additional embodiments, a second coating layer 44 (FIG. 2B) may be deposited on the exterior face 36 of the exterior wall substrate 32 prior to depositing first coating layer 42, such that the second coating layer 44 is disposed between the exterior face 36 and the first coating layer 42. Second coating layer 44 may comprise a metallic bonding layer. Together, first and second coating layers 42, 44 may comprise a thermal barrier coating over exterior wall substrate 32.

In some embodiments, cooling holes 40 may be formed subsequent to the deposition of first coating layer 42. Cooling holes 40 may be formed using electrical discharge machining (EDM), among other techniques.

As shown in FIG. 4, first coating layer 42 may not coat an exterior face 48 of each plateau 38 in the plurality of plateaus 38. This may be accomplished according to any of several embodiments of the disclosure. In one embodiment, first coating layer 42 is deposited on exterior face 36 of exterior wall substrate 32 to a depth that is less than a height of the plateau 38, such that an upper surface 48 of each plateau 38 is not covered during deposition of the first coating layer 42. In another embodiment, first coating layer 42 is deposited on exterior face 36 of the exterior wall substrate 32 to a depth that is greater than or equal to a height of the plateau 38, such that an upper surface 48 of the plateau 38 is covered by the first coating layer 42. First coating layer 42 may then be removed from upper surface 48 of each plateau 38. Such removal may be performed by grinding or other means. In still another embodiment, a cover or cap is placed over upper surface 48 of each plateau 38 prior to deposition of first coating layer 42. Following deposition of first coating layer 42, the cover or cap may be removed, leaving upper surface 48 uncovered. In any of the foregoing embodiments, the result is that upper surface 48 of plateau 38 is not covered by first coating layer 42. In embodiments in which second coating layer 44 is present, upper surface 48 is also not covered by second coating layer 44, as shown in FIG. 2B.

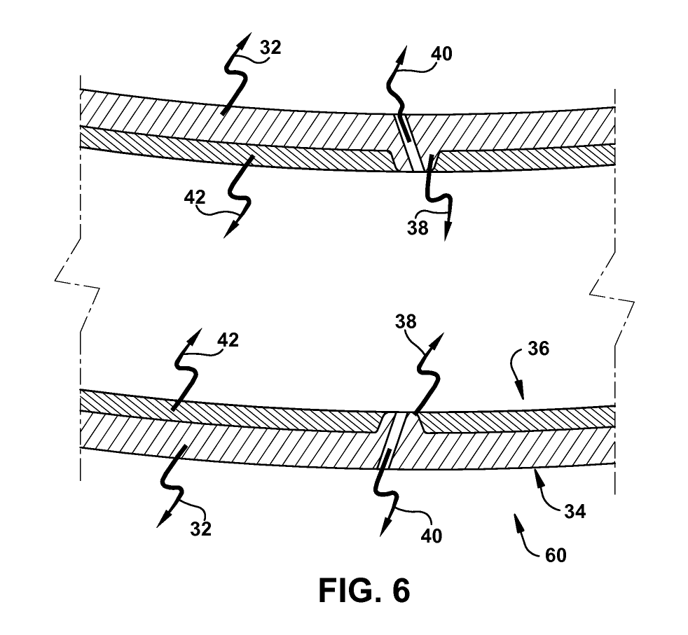

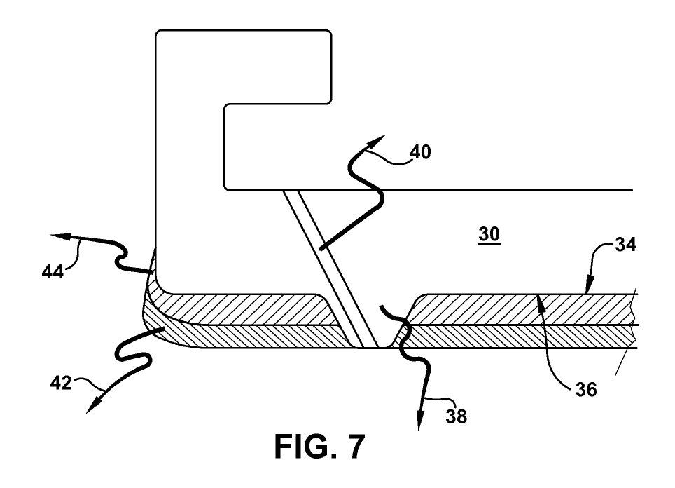

The resulting component 30, described above with reference to FIGS. 2A-B may then be used in the field in a turbomachine. In various embodiments, component 30 may be one of an airfoil portion of a bucket (FIGS. 2A-B), a nozzle (not shown), a transition piece (not shown), a retaining ring (not shown), a sidewall 50 (FIG. 5), a combustor exhaust component 60 (FIG. 6), or a shroud (FIG. 7).

In any of these cases, during operation component 30 may be subjected to high temperatures which may cause first coating layer 42 to reach the end of its useful life sooner than exterior wall substrate 32 and other portions of component 30. Component 30 may be removed from the turbomachine in which it is used, and stripped to remove first coating layer 42 and, if present, second coating layer 44 from component 30. First coating layer 42, or both of first and and second coating layers 42, 44 may then be re-deposited on exterior wall substrate 32 as described above, such that an upper surface 48 of each plateau 38 is not covered by the first coating layer 42. Component 30 may then be returned to use in the field for another interval.

As used herein, the terms “first,” “second,” and the like, do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to about 25 mm, or, more specifically, about 5 mm to about 20 mm,” is inclusive of the endpoints and all intermediate values of the ranges of “about 5 mm to about 25 mm,” etc.).

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A component for use in a turbomachine, the component comprising:
an exterior wall substrate having an interior face and an exterior face,
at least one plateau disposed on the exterior face;
a plurality of cooling holes providing a fluid passageway between the interior face and the exterior face of the exterior wall substrate, each cooling hole in the plurality of cooling holes being disposed such that it passes through one of the at least one plateau; and
a first coating layer disposed on the exterior face of the exterior wall substrate, wherein the first coating layer is non-metallic,
wherein the first coating layer does not cover an exterior face of each plateau in the plurality of plateaus.

2. The component of claim 1, further comprising a second coating layer disposed between the first coating layer and the exterior face of the exterior wall substrate.

3. The component of claim 2, wherein the second coating layer comprises at least one metallic bonding layer.

4. The component of claim 1, wherein the first coating layer comprises a ceramic.

5. The component of claim 1, wherein the exterior wall substrate comprises a metal.

6. The component of claim 1, wherein the component includes one of a bucket, a shroud, a nozzle, a transition piece, a retaining ring, a sidewall, or a combustor exhaust component.

7. The component of claim 1, wherein each plateau has a width of about 0.0254 cm to about 1.02 cm, and a height of about 0.013 cm to about 0.178 cm.

8. A method of constructing a component for use in a turbomachine, the method comprising:
forming an exterior wall substrate, wherein the exterior wall substrate includes
an interior face and an exterior face, and
a plurality of plateaus disposed on the exterior face;
forming a plurality of cooling holes providing a fluid passageway between the interior face and the exterior face of the exterior wall substrate, wherein each cooling hole is disposed such that it passes through one of the plurality of plateaus; and
depositing a first coating layer on the exterior face of the exterior wall substrate, wherein the first coating layer is non-metallic.

9. The method of claim 8, further comprising depositing a second coating layer on the exterior face of the exterior wall substrate prior to the depositing of the first coating layer, such that the second coating layer is disposed between the exterior face and the first coating layer.

10. The method of claim 9, wherein the second coating layer comprises a metallic bonding layer.

11. The method of claim 8, wherein the first coating layer comprises ceramic.

12. The method of claim 8, wherein the exterior wall substrate comprises a metal.

13. The method of claim 8, wherein the component includes one of a bucket, a shroud, a nozzle, a transition piece, a retaining ring, a sidewall, or a combustor exhaust component.

14. The method of claim 8, wherein the process of forming the exterior wall substrate further comprises casting the exterior wall substrate.

15. The method of claim 8, wherein the process of forming the plurality of cooling holes further comprises electrical discharge machining (EDM) through the exterior wall substrate.

16. The method of claim 8, wherein the depositing a first coating layer on the exterior face of the exterior wall substrate further comprises
placing a cover over each plateau in the plurality of plateaus;
depositing the first coating layer over the exterior wall substrate and the cover over each of the plurality of plateaus; and
removing the cover from over each plateau, such that an upper surface of each plateau is not covered by the first coating layer.

17. The method of claim 8, wherein the depositing of the first coating layer on the exterior face of the exterior wall substrate further comprises depositing the first coating layer to a depth that is greater than or equal to a height of the plateau, such that an upper surface of the plateau is covered by the first coating layer, and
the method further comprises removing the first coating from the upper surface of each plateau.

18. The method of claim 17, wherein the removing further comprises grinding.

19. The method of claim 8, wherein each plateau has a width of about 0.0254 cm to about 1.02 cm, and a height of about 0.013 cm to about 0.178 cm

20. The method of claim 8, further comprising:
stripping the component to remove the first coating layer, and
re-depositing the first coating layer on the exterior wall substrate such that it covers the exterior wall substrate but does not cover an upper surface of each of the plurality of plateaus.
